(19) United States
(12) Patent Application Publication
(10) Pub. No.: US 2025/0020810 A1
(43) Pub. Date: Jan. 16, 2025

(54) VEHICLE COLLISION DETECTION METHOD, SYSTEM AND VEHICLE

(71) Applicant: Huizhou DESAY SV Automotive Co., Ltd., Huizhou (CN)

(72) Inventors: Wei Lu, Huizhou (CN); Dexiang Wang, Huizhou (CN); Qingye Chen, Huizhou (CN)

(21) Appl. No.: 18/900,984

(22) Filed: Sep. 30, 2024

Related U.S. Application Data
(63) Continuation of application No. PCT/CN2023/141752, filed on Dec. 26, 2023.

(30) Foreign Application Priority Data
May 22, 2023 (CN) 202310574584.2

(51) Int. Cl. G01S 17/931; G01S 17/86; G01S 17/89; G08G 1/16

(52) U.S. Cl. CPC G01S 17/931; G01S 17/86; G01S 17/89; G08G 1/16

(57) ABSTRACT

The present application provides a vehicle collision detection method and system and a vehicle. The vehicle collision detection method includes: dividing an acquired collection of obstacle information into a first obstacle map and a second obstacle map based on a preset obstacle height; modeling a current vehicle based on the first obstacle map and the second obstacle map, and fusing modeling results with the first obstacle map and the second obstacle map to obtain a first collision detection model and a second collision detection model; and further, obtaining a distance relationship between a preset position of the current vehicle and obstacles corresponding to the collection of obstacle information through the first collision detection model and/or the second collision detection model, and determining whether the current vehicle is in collision based on the distance relationship.

### CROSS-REFERENCE TO RELATED APPLICATION

The present application is a continuation of PCT application No. PCT/CN2023/141752, filed on Dec. 26, 2023, which designates United States and claims priority of China Patent Application No. 202310574584.2, filed on May 22, 2023, the contents of which are incorporated herein by reference.

### BACKGROUND OF THE INVENTION

### 1. Technical Field

The present application relates to the technical field of intelligent driving, in particular to a vehicle collision detection method and system and a vehicle.

### 2. Description of Related Art

With the rapid development of intelligent driving, the automatic driving function of automobiles is becoming more and more popular. While the automatic driving function brings convenience to people, there are also some issues with poor experience, such as scratching rear-view mirrors, hitting the curb or having a collision accident, leading some users to dare not use the automatic driving function, which is not conducive to the development of intelligent driving.

In the prior art, the distance between a current vehicle and an obstacle can be acquired based on sensor data, and then collision detection analysis and warning are carried out. However, data transmitted by sensors has inaccuracies and delays, so that collision detection fails to be carried out in time. Moreover, sensors cannot conduct corresponding collision detection for different vehicles according to the height of an obstacle, resulting in the collision between the current vehicle and the obstacle in the driving process, which may cause casualties in serious cases.

### SUMMARY OF THE INVENTION

In order to solve the technical problems that in the prior art, collision detection cannot be carried out in time due to the inaccuracy and delay of data transmitted by sensors, and the sensors cannot carry out corresponding collision detection for different vehicles according to the height of obstacles, resulting in the collision between a current vehicle and the obstacles during the driving process, the present application provides a method and system capable of carrying out vehicle collision detection based on height of obstacles.

Specifically, the present application provides a vehicle collision detection method. The method includes the following steps: S100: acquiring a collection of obstacle information within a preset range of a current vehicle, and dividing the collection of obstacle information into a first obstacle map and a second obstacle map based on a preset obstacle height; S200: modeling the current vehicle based on the first obstacle map and the second obstacle map, and fusing vehicle models with the corresponding obstacle maps to obtain a first collision detection model and a second collision detection model, respectively; and S300: obtaining a distance relationship between a preset position of the current vehicle and obstacles corresponding to the collection of obstacle information through the first collision detection model and/or the second collision detection model, and determining whether the current vehicle is in collision based on the distance relationship.

In the above technical solution, the obstacle maps are divided according to the height of an obstacle, then the corresponding collision detection models are built, and the distance relationship between the current vehicle and the obstacle is determined through the collision detection models to obtain the collision risk. The collision risk may be analyzed accurately in real time for different types of obstacle heights, the accuracy and efficiency of collision detection are improved, and the driving safety of the vehicle and the personal safety of occupants are further guaranteed.

Further, the dividing the collection of obstacle information into a first obstacle map and a second obstacle map based on a preset obstacle height in step S100 includes: calibrating maximum lengths of front wheels and rear wheels of the current vehicle, respectively, and setting the preset obstacle height according to calibration results; and determining whether heights of the obstacles corresponding to the collection of obstacle information are greater than the preset obstacle height, if yes, classifying the obstacles into the first obstacle map, otherwise classifying the obstacles into the second obstacle map.

In the above technical solution, by calibrating the preset obstacle height according to the lengths of the front and rear wheels of the vehicle, and classifying obstacles with different obstacle heights into the different maps, analysis of collision detection is more targeted, which further improves the accuracy and efficiency of collision detection.

Further, step S200 includes: modeling the current vehicle to obtain a first vehicle model including a front overhang and a rear overhang of the vehicle, and a second vehicle model with the front overhang and the rear overhang of the vehicle removed; and fusing the first vehicle model and the second vehicle model with the first obstacle map and the second obstacle map, respectively, to obtain the first collision detection model and the second collision detection model.

The vehicle models are obtained and fused into the corresponding obstacle maps to obtain the corresponding collision detection models for use in subsequent analysis of collision detection.

In the above technical solution, the maximum lengths of the front and rear wheels of the current vehicle are calibrated, so that models corresponding to various vehicles and the collision detection models correspond and are unique, making the collision detection more personalized and intelligent.

Further, before performing step S300, the method includes: building a first rectangular coordinate system with a geometric center of the current vehicle as a first origin, a width direction of the current as an x-axis, and a length direction of the vehicle as a y-axis; and building a second rectangular coordinate system with a midpoint of a rear axle of the current vehicle as a second origin, the width direction of the vehicle as an X-axis, and the length direction of the vehicle as a Y-axis.

In the above technical solution, by building the first rectangular coordinate system and the second rectangular coordinate system, not only may datamation of the positions of the obstacles be determined, subsequent determination of the first preset circular region and the second preset circular region is also facilitated.

Further, step S300 includes: S301: acquiring, in the first collision detection model, initial obstacle coordinates of the obstacles under the first rectangular coordinate system; S302: calculating a distance between each obstacle and the first origin based on the initial obstacle coordinates and coordinates of the first origin, if the distance between at least one of the obstacles and the first origin is smaller than a first preset distance, performing step S303, otherwise performing step S305.

In the above technical solution, obstacles with collision risk are first screened out to narrow down the range before proceeding to the next step of collision risk detection.
S303: Acquiring transformed obstacle coordinates of obstacles in a first preset circular region under the second rectangular coordinate system, and proceeding to step S304.

In the above technical solution, the transformed obstacle coordinates under the second rectangular coordinate system are used here to reduce the influence of the vehicle heading angle on the obstacle coordinates, so that obtained results of the distance between the obstacle and the current vehicle are more accurate, and the accuracy of collision detection is further improved.
S304: Calculating a distance between each obstacle in the first preset circular region and the second origin based on the transformed obstacle coordinates and coordinates of the second origin, if the distance between at least one of the obstacles in the first preset circular region and the second origin is smaller than a second preset distance, determining that the current vehicle is in collision, otherwise performing step S305.

It is to be noted that the second preset distance is typically preferably half the width of the vehicle, or the length of the rear overhang of the vehicle, or the distance between the rear axle and the front overhang of the vehicle; herein, obstacles that may collide with the vehicle are further limited, so as to determine whether the current vehicle has a risk of collision.
S305: Determining that the current vehicle has no risk of collision.

The first preset circle region takes the first origin as a center of the circle and the first preset distance as a radius.

Further, step S300 further includes: S311: acquiring, in the second collision detection model, initial obstacle coordinates of the obstacles under the first rectangular coordinate system; S312: calculating a distance between each obstacle and the first origin based on the initial obstacle coordinates and coordinates of the first origin, if the distance between at least one of the obstacles and the first origin is smaller than a third preset distance, performing step S313, otherwise performing step S315; S313: acquiring transformed obstacle coordinates of obstacles in a second preset circular region under the second rectangular coordinate system, and proceeding to step S314; S314: calculating a distance between each obstacle in the second preset circular region and the second origin based on the transformed obstacle coordinates and coordinates of the second origin, if the distance between at least one of the obstacles in the second preset circular region and the second origin is smaller than a second preset distance, determining that the current vehicle is in collision, otherwise performing step S315; and S315: determining that the current vehicle has no risk of collision.

The second preset circle region takes the first origin as a center of the circle and the third preset distance as a radius.

Further, step S303 or S313 specifically includes: acquiring a vehicle heading angle, corresponding initial obstacle coordinates of the obstacles in the first preset circular region or the second preset circular region under the first rectangular coordinate system, and coordinates of the midpoint of the rear axle of the vehicle under the first rectangular coordinate system; calculating a first included angle based on the initial obstacle coordinates and the coordinates of the midpoint of the rear axle of the vehicle, and calculating a distance between each obstacle and the midpoint of the rear axle of the vehicle, wherein the first included angle is an included angle between a connecting line of each obstacle and the midpoint of the rear axle of the vehicle and a perpendicular line segment from the obstacle to the X-axis of the second rectangular coordinate system; calculating a second included angle based on the first included angle and the vehicle heading angle; and calculating the transformed obstacle coordinates of each obstacle based on the distance between the obstacle and the midpoint of the rear axle of the vehicle and the second included angle.

In the above technical solution, the transformed obstacle coordinates remove the influence of the vehicle heading angle thereon, which further helps to improve the accuracy of subsequent collision detection.

Further, when it is determined that the current vehicle is in collision, step S304 or S314 further includes: issuing a collision warning message.

In the above technical solution, by issuing the collision warning message, a driver may be reminded to take emergency measures in time to reduce the possibility of an accident, thereby improving driving safety and guaranteeing the safety of the vehicle and the driver and passengers.

Based on the same concept, the present application further provides a vehicle collision detection system. The system includes: a first acquisition module configured to acquire a collection of obstacle information within a preset range of a current vehicle; a dividing module configured to divide the collection of obstacle information into a first obstacle map and a second obstacle map based on a preset obstacle height; a second acquisition module configured to model the current vehicle configured based on the first obstacle map and the second obstacle map, and fuse vehicle models with the corresponding obstacle maps to obtain a first collision detection model and a second collision detection model, respectively; and a determining module configured to obtain a distance relationship between a preset position of the current vehicle and obstacles corresponding to the collection of obstacle information through the first collision detection model and/or the second collision detection model, and determine whether the current vehicle is in collision based on the distance relationship.

Further, the system further includes: a building module configured to build a first rectangular coordinate system and a second rectangular coordinate system, wherein the first rectangular coordinate system takes a geometric center of the current vehicle as a first origin, a width direction of the current as an x-axis, and a length direction of the vehicle as a y-axis; and the second rectangular coordinate system takes a midpoint of a rear axle of the current vehicle as a second origin, the width direction of the vehicle as an X-axis, and the length direction of the vehicle as a Y-axis; and a warning module configured to issue a collision warning message when it is determined that the current vehicle is in collision.

Further, the dividing module includes: a calibration unit configured to calibrate maximum lengths of front wheels and rear wheels of the current vehicle; a setting unit configured to set the preset obstacle height according to calibration results of the calibration unit; and a dividing unit configured to determine whether heights of the obstacles corresponding to the collection of obstacle information are greater than the preset obstacle height; if yes, classify the obstacles into the first obstacle map; otherwise, classify the obstacles into the second obstacle map.

Further, the second acquisition module includes: a modeling unit configured to obtain a first vehicle model and a second vehicle model; and a fusion unit configured to fuse the first vehicle model and the second vehicle model with the first obstacle map and the second obstacle map, respectively, to obtain the first collision detection model and the second collision detection model.

Further, the determining module includes: an acquisition unit configured to acquire, in the first collision detection model or the second collision detection model, initial obstacle coordinates of the obstacles under the first rectangular coordinate system; a first calculation unit configured to calculate a distance between each obstacle and the first origin based on the initial obstacle coordinates and coordinates of the first origin to obtain transformed obstacle coordinates of obstacles in a second preset circular region under the second rectangular coordinate system when the distance is smaller than a first preset distance or a third preset distance; and a second calculation unit configured to calculate a distance between each obstacle in the second preset circular region to the second origin based on the transformed obstacle coordinates and coordinates of the second origin, so as to determine that the current vehicle is in collision when the distance is smaller than a second preset distance.

By means of the system, the collision risk may be analyzed accurately for different types of obstacle heights, the accuracy of collision detection is improved, and the driving safety of the vehicle and the personal safety of occupants are further guaranteed.

Based on the same concept, the present application further provides a vehicle. The vehicle is configured with a vehicle collision detection system, and the system detects whether a current vehicle is in collision using the vehicle collision detection method described above.

Compared with the prior art, the present application has the following beneficial effects. According to the present application, the collection of obstacle information is divided into the first obstacle map and the second obstacle map, then the first collision detection model and the second collision detection model are correspondingly built, and the distance relationship between the current vehicle and the obstacle is determined through the first collision detection model or the second collision detection model, so as to obtain the collision risk between the current vehicle and the obstacle. By means of the present application, the collision risk can be analyzed accurately for different types of obstacle heights, the accuracy of collision detection is improved, and the driving safety of the vehicle and the personal safety of occupants are further guaranteed.

### BRIEF DESCRIPTION OF THE SEVERAL VIEWS OF THE DRAWINGS

The foregoing and other exemplary purposes, aspects and advantages of the present invention will be better understood in principle from the following detailed description of one or more exemplary embodiments of the invention with reference to the drawings, in which:

FIG. 1 is a flowchart of a vehicle collision detection method according to the present application.

FIG. 2 is a flowchart of a method for performing collision detection using a first collision detection model in FIG. 1.

FIG. 3 is a flowchart of a method for performing collision detection using a second collision detection model in FIG. 1.

FIG. 4 is a system framework diagram of a vehicle collision detection method in FIG. 1.

### DETAILED DESCRIPTION OF THE INVENTION

The invention will now be described in detail through several embodiments with reference to the accompanying drawings.

The present application provides a vehicle collision detection method and system and a vehicle, in order to solve the technical problems that in the prior art, collision detection is inaccurate and inefficient due to the use of sensors for the detection of the distance between a vehicle and an obstacle, and corresponding collision detection cannot be carried out for different vehicles according to the height of the obstacle.

The present application provides a vehicle collision detection method and system and a vehicle. The overall solution is as follows: acquiring a collection of obstacle information within a preset range of a current vehicle, determining whether heights of obstacles corresponding to the collection of obstacle information are greater than a preset obstacle height, if yes, classifying the obstacles into a first obstacle map, otherwise classifying the obstacles into a second obstacle map; then modeling the current vehicle based on the first obstacle map and the second obstacle map, and performing fusion to obtain a first collision detection model and a second collision detection model; obtaining a distance relationship between a geometric center of the current vehicle and the obstacles corresponding to the collection of obstacle information through the first collision detection model and/or the second collision detection model; if the distance between at least one of the obstacles and the geometric center is smaller than a first set distance, obtaining a distance relationship between a midpoint of a rear axle of the current vehicle and the obstacles; and if the distance between at least one of the obstacles and the midpoint of the rear axle of the current vehicle is smaller than a second preset distance, determining that the current vehicle is in collision.

The vehicle collision detection method and system and the vehicle of the present application are described in further detail below in connection with specific embodiments and the accompanying drawings.

### First Embodiment

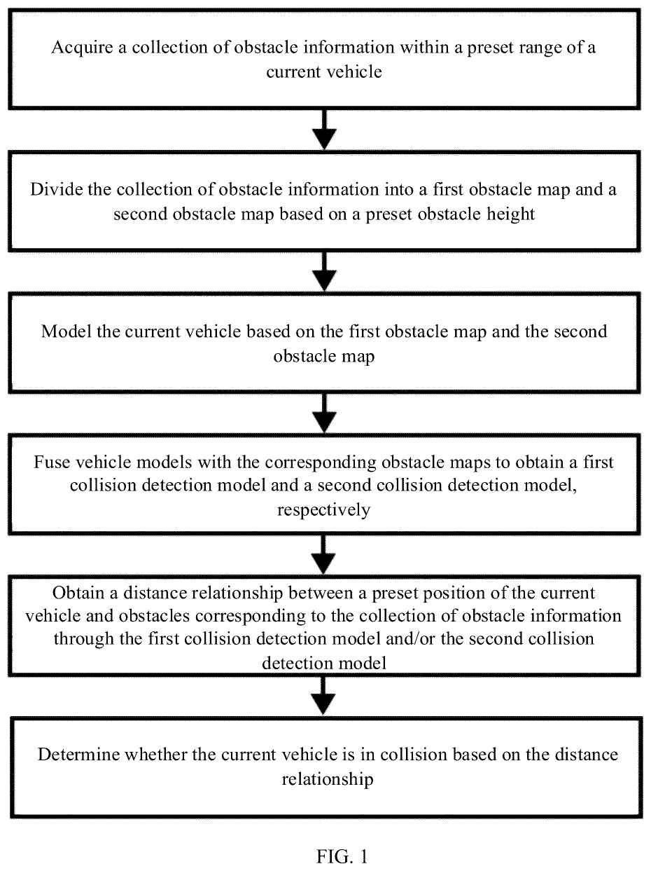

Referring to FIG. 1, the present application provides a vehicle collision detection method. The method includes the following steps: S100: Acquiring a collection of obstacle information within a preset range of a current vehicle, and divide the collection of obstacle information into a first obstacle map and a second obstacle map based on a preset obstacle height.

Further, the dividing the collection of obstacle information into a first obstacle map and a second obstacle map based on a preset obstacle height in step
S100 includes: calibrating maximum lengths of front wheels and rear wheels of the current vehicle, and setting the preset obstacle height according to calibration results; and determining whether heights of the obstacles corresponding to the collection of obstacle information are greater than the preset obstacle height, if yes, classifying the obstacles into the first obstacle map, otherwise classifying the obstacles into the second obstacle map.

Because chassis heights and vehicle heights vary from vehicle to vehicle, the preset obstacle height is calibrated according to an actual vehicle, and the specific value of the preset obstacle height is not limited herein.

It is to be noted that it may be considered that the first obstacle map is a body non-encroachable map and the second obstacle map is a body encroachable map, where body encroachable means that front and rear overhangs of the vehicle are encroachable due to a limiter or a low curb or the like.

After the division of the first obstacle map and the second obstacle map is completed, step S200 may be performed.

S200: Modeling the current vehicle based on the first obstacle map and the second obstacle map, and fuse vehicle models with the corresponding obstacle maps to obtain a first collision detection model and a second collision detection model, respectively.

Further, step S200 includes: modeling the current vehicle to obtain a first vehicle model including a front overhang and a rear overhang of the vehicle, and a second vehicle model with the front overhang and the rear overhang of the vehicle removed.

It is to be noted that the vehicle models are not 3d models, but two-dimensional planar models of the surrounding contour of a vehicle. The first vehicle model is the surrounding contour of the entire vehicle including the front and rear overhangs of the vehicle, presenting a rounded rectangle, and the front and rear wheels of the vehicle are correspondingly identified by four rectangles, respectively. The second vehicle model is a rectangular contour map with the front and rear overhangs of the vehicle removed, and the corners of the contour map are where the wheels are located.

The first vehicle model and the second vehicle model are fused with the first obstacle map and the second obstacle map, respectively, to obtain the first collision detection model and the second collision detection model.

The first collision detection model or the second collision detection model may embody a position of an obstacle of the collection of obstacle information relative to a corresponding vehicle model, where an obstacle is presented in the form of a data point.

After completing the acquisition of the first collision detection model and the second collision detection model, step S300 may be performed.
S300: Obtaining a distance relationship between a preset position of the current vehicle and obstacles corresponding to the collection of obstacle information through the first collision detection model and/or the second collision detection model, and determine whether the current vehicle is in collision based on the distance relationship.

Before performing step S300, the method includes: building a first rectangular coordinate system with a geometric center of the current vehicle as a first origin, a width direction of the current as an x-axis, and a length direction of the vehicle as a y-axis; and building a second rectangular coordinate system with a midpoint of a rear axle of the current vehicle as a second origin, the width direction of the vehicle as an X-axis, and the length direction of the vehicle as a Y-axis.

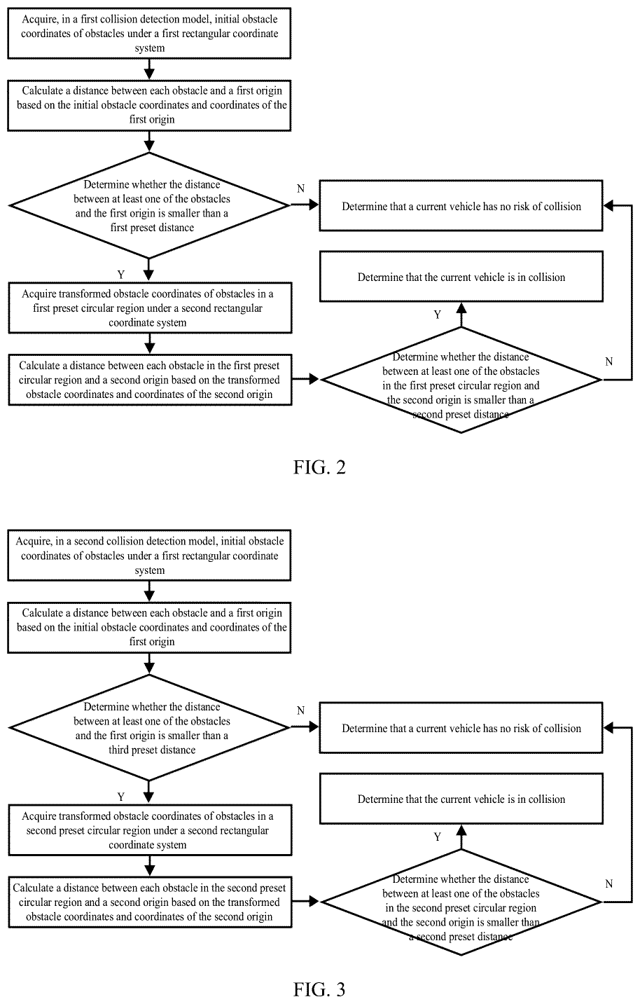

Further, referring to FIG. 2, step S300 includes: S301: Acquiring, in the first collision detection model, initial obstacle coordinates (xᵢ, yᵢ) of the obstacles under the first rectangular coordinate system.
S302: Calculating a distance L0i between each obstacle and the first origin based on the initial obstacle coordinates (xᵢ, yᵢ) and coordinates (x₀, y₀) of the first origin, where

$${L}_{0 i} = \sqrt{{( {x}_{i} - {x}_{0} )}^{2} + {( {y}_{i} - {y}_{0} )}^{2}}$$

If the distance between at least one of the obstacles and the first origin is smaller than a first preset distance, step S303 is performed; otherwise step S305 is performed.

It is to be noted that the first preset distance is a distance between the geometric center of the current vehicle and any corner of the vehicle, because the geometric center of the vehicle is selected here, the distance between the geometric center and any corner of the vehicle is the same, and the distance may be arbitrarily selected in the practical application. For example, the distance between the geometric center of the current vehicle and the front right corner of the vehicle is measured and defined as the first preset distance.

When the vehicle collision detection method is applied in the automatic parking process, the positional relationship between the obstacle and the current vehicle is determined based on the distance between the geometric center of the vehicle and any corner of the vehicle, and obstacles with a certain collision risk in the automatic parking process, such as forwarding, reversing and turning, may be screened out.
S303: Acquiring transformed obstacle coordinates of obstacles in a first preset circular region under the second rectangular coordinate system.

The first preset circle region takes the first origin as a center of the circle and the first preset distance as a radius.

Further, step S303 specifically includes: acquiring a vehicle heading angle θ, corresponding initial obstacle coordinates (xₙ, yₙ) of the obstacles in the first preset circular region under the first rectangular coordinate system, and coordinates (x, y) of the midpoint of the rear axle of the vehicle under the first rectangular coordinate system; calculating a first included angle θ1 based on the initial obstacle coordinates and the coordinates of the midpoint of the rear axle of the vehicle, and calculating a distance L between each obstacle and the midpoint of the rear axle of the vehicle,

where θ1=arctan((xₙ−x)/(yₙ−y),L=\sqrt{(xₙ−x)²+(yₙ−y)²}, and

the first included angle θ1 is an included angle between a connecting line of each obstacle and the midpoint of the rear axle of the vehicle and a perpendicular line segment from the obstacle to the X-axis of the second rectangular coordinate system; calculating a second included angle θ2 based on the first included angle and the vehicle heading angle, where θ2=θ1−θ; and calculating the transformed obstacle coordinates (xₘ, yₘ) of each obstacle based on the distance L between the obstacle and the midpoint of the rear axle of the vehicle and the second included angle θ2, where xₘ=L*sin (θ2) and yₘ=L*cos (θ2).
S304: Calculating a distance between each obstacle in the first preset circular region and the second origin based on the transformed obstacle coordinates and coordinates of the second origin, if the distance between at least one of the obstacles in the first preset circular region and the second origin is smaller than a second preset distance, determining that the current vehicle is in collision, otherwise perform step S305.

It is to be noted that the second preset distance is typically preferably half the width of the vehicle, or the length of the rear overhang of the vehicle, or the distance between the rear axle and the front overhang of the vehicle.

When xₘ is less than half the width of the vehicle, or yₘ is less than the length of the rear overhang of the vehicle, or yₘ is less than the distance between the rear axle and the front overhang of the vehicle, it is determined that the current vehicle is in collision.

Further, when it is determined that the current vehicle is in collision, S304 further includes: issuing a collision warning message.

A system may issue the collision warning message in real time through an on-board display or sound prompts, and may also send the warning message to a cell phone of a driver or an Internet of Vehicles platform at the same time, to remind the driver to take emergency measures, thereby reducing the occurrence of collision accidents.
S305: Determining that the current vehicle has no risk of collision.

### Second Embodiment

Referring to FIG. 3, the present application further provides a deformed example of collision detection via the second collision detection model for an encroachable obstacle. Step S300 further includes: S311: Acquiring, in the second collision detection model, initial obstacle coordinates of the obstacles under the first rectangular coordinate system.
S312: Calculating a distance between each obstacle and the first origin based on the initial obstacle coordinates and coordinates of the first origin, if the distance between at least one of the obstacles and the first origin is smaller than a third preset distance, performing step S313, otherwise performing step S315.

It is to be noted that the third preset distance is a distance between the geometric center of the current vehicle and either side of the front or rear axle of the vehicle.
S313: Acquiring transformed obstacle coordinates of obstacles in a second preset circular region under the second rectangular coordinate system.

The second preset circle region takes the first origin as a center of the circle and the third preset distance as a radius.

Further, step S313 specifically includes: acquiring a vehicle heading angle, corresponding initial obstacle coordinates of the obstacles in the second preset circular region under the first rectangular coordinate system, and coordinates of the midpoint of the rear axle of the vehicle under the first rectangular coordinate system; calculating a first included angle based on the initial obstacle coordinates and the coordinates of the midpoint of the rear axle of the vehicle, and calculating a distance between each obstacle and the midpoint of the rear axle of the vehicle, where the first included angle is an included angle between a connecting line of each obstacle and the midpoint of the rear axle of the vehicle and a perpendicular line segment from the obstacle to the X-axis of the second rectangular coordinate system; calculating a second included angle based on the first included angle and the vehicle heading angle; and calculating the transformed obstacle coordinates of each obstacle based on the distance between the obstacle and the midpoint of the rear axle of the vehicle and the second included angle.
S314: Calculating a distance between each obstacle in the second preset circular region and the second origin based on the transformed obstacle coordinates and coordinates of the second origin, if the distance between at least one of the obstacles in the second preset circular region and the second origin is smaller than a second preset distance, determining that the current vehicle is in collision, otherwise perform step S315.

Further, when it is determined that the current vehicle is in collision, S314 further includes: issuing a collision warning message.
S315: Determining that the current vehicle has no risk of collision.

### Third Embodiment

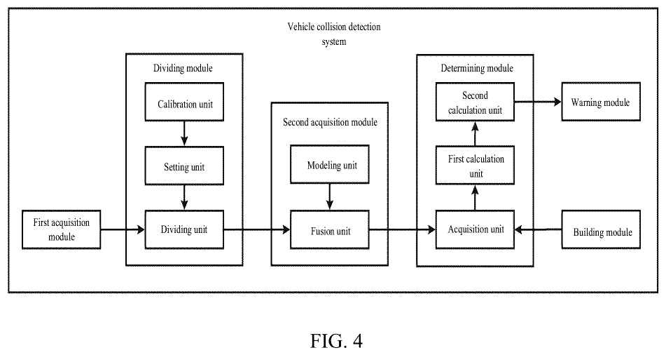

Referring to FIG. 4, the present application further provides a vehicle collision detection system. The system includes: a first acquisition module configured to acquire a collection of obstacle information within a preset range of a current vehicle.

In a feasible implementation, the collection of obstacle information may be obtained by target sensors, and the target sensors may be sensors corresponding to LIDAR and a stereo camera. The LIDAR may be provided on both sides of the bottom end of the vehicle to be symmetrical left and right or front and back, in order to obtain information of obstacles that are far away and in a low position, and require high detection accuracy. The stereo camera is provided on the top of the vehicle to obtain information about obstacles that are close and in a high position. Through the combination of the LIDAR and the stereo camera, the acquired collection of obstacle information is more comprehensive and accurate, so as to help detect more accurately during subsequent collision detection, and to prevent the occurrence of collision accidents caused by missing obstacle detection.

The system includes a dividing module configured to divide the collection of obstacle information into a first obstacle map and a second obstacle map based on a preset obstacle height.

The dividing module includes: a calibration unit configured to calibrate maximum lengths of front wheels and rear wheels of the current vehicle; a setting unit configured to set the preset obstacle height according to calibration results of the calibration unit, where it is to be noted that because chassis heights and vehicle heights vary from vehicle to vehicle, the preset obstacle height is calibrated according to an actual vehicle, which is not limited herein; and a dividing unit configured to determine whether heights of obstacles corresponding to the collection of obstacle information are greater than the preset obstacle height; if yes, classify the obstacles into the first obstacle map; otherwise, classify the obstacles into the second obstacle map.

The system further includes a second acquisition module configured to model the current vehicle configured based on the first obstacle map and the second obstacle map, and fuse vehicle models with the corresponding obstacle maps to obtain a first collision detection model and a second collision detection model, respectively.

The second acquisition module includes: a modeling unit configured to obtain a first vehicle model and a second vehicle model; and a fusion unit configured to fuse the first vehicle model and the second vehicle model with the first obstacle map and the second obstacle map, respectively, to obtain the first collision detection model and the second collision detection model.

The system further includes a determining module configured to obtain a distance relationship between a preset position of the current vehicle and the obstacles corresponding to the collection of obstacle information through the first collision detection model and/or the second collision detection model, and determine whether the current vehicle is in collision based on the distance relationship.

The system further includes: a building module configured to build a first rectangular coordinate system and a second rectangular coordinate system. The first rectangular coordinate system takes a geometric center of the current vehicle as a first origin, a width direction of the current as an x-axis, and a length direction of the vehicle as a y-axis; and the second rectangular coordinate system takes a midpoint of a rear axle of the current vehicle as a second origin, the width direction of the vehicle as an X-axis, and the length direction of the vehicle as a Y-axis.

The determining module includes: an acquisition unit configured to acquire, in the first collision detection model or the second collision detection model, initial obstacle coordinates of the obstacles under the first rectangular coordinate system; a first calculation unit configured to calculate a distance between each obstacle and the first origin based on the initial obstacle coordinates and coordinates of the first origin, so as to obtain transformed obstacle coordinates of obstacles in a second preset circular region under the second rectangular coordinate system when the distance is smaller than a first preset distance or a third preset distance; and a second calculation unit configured to calculate a distance between each obstacle in the second preset circular region to the second origin based on the transformed obstacle coordinates and coordinates of the second origin, so as to determine that the current vehicle is in collision when the distance is smaller than a second preset distance.

The system further includes: a warning module configured to issue a collision warning message when it is determined that the current vehicle is in collision.

### Fourth Embodiment

The present application further provides a vehicle. The vehicle is configured with a vehicle collision detection system, and the system detects whether a current vehicle is in collision using the vehicle collision detection method described above.

In summary, the present application provides the vehicle collision detection method and system and the vehicle. The obstacle maps are divided according to the height of an obstacle, then the corresponding collision detection models are built, and the distance relationship between the current vehicle and the obstacle is determined through the collision detection models to obtain the collision risk. The collision risk can be analyzed accurately in real time for different types of obstacle heights, the accuracy and efficiency of collision detection are improved, and the driving safety of the vehicle and the personal safety of occupants are further guaranteed.

Although exemplary embodiments have been described herein with reference to the accompanying drawings, it should be understood that the above exemplary embodiments are merely exemplary and are not intended to limit the scope of the present application. Various changes and modifications may be made therein by a person of ordinary skill in the art without departing from the scope and spirit of the present application. All such changes and modifications are intended to fall within the scope of the present application as required by the appended claims.

A person of ordinary skill in the art may realize that the units and algorithmic steps of the various examples described in conjunction with the embodiments disclosed herein are capable of being implemented in electronic hardware, or a combination of computer software and electronic hardware. Whether these functions are performed in hardware or software depends on the particular application and design constraints of the technical solution. A person skilled in the art may use different methods to implement the described functions for each particular application, but such implementations should not be considered outside the scope of the present application.

In the several embodiments provided in the present application, it should be understood that the disclosed devices and methods may be implemented in other ways. For example, the device embodiment described above is merely illustrative, for example, the units may be divided merely based on logical functions, while in practical implementations, there may be other division methods. For example, a plurality of units or components may be combined or integrated into another device, or some features may be omitted or not performed.

Various component embodiments of the present application may be implemented in hardware, or in software modules running on one or more processors, or a combination thereof. Those skilled in the art should understand that microprocessors or digital signal processors (DSPs) may be used in practice to implement some or all of the functionality of some of the modules according to embodiments of the present application. The present application may also be implemented as an apparatus program (e.g., computer programs and computer program products) for performing some or all of the methods described herein. Such a program implementing the present application may be stored on a computer-readable medium or may have the form of one or more signals. Such signals may be available for download from an Internet site, or provided on a carrier signal, or in any other form.

It is to be noted that relational terms such as first and second herein are only used to distinguish one entity or operation from another entity or operation, and do not necessarily require or imply any such actual relationship or order between these entities or operations. Moreover, the terms “comprise”, “include” or any other variants thereof are intended to cover non-exclusive inclusion, so that a process, method, article or device including a series of elements not only includes those elements, but also includes other elements not clearly listed, or also includes elements inherent to this process, method, article or device. An element proceeded by the phrase “comprises a” does not, without more constraints, preclude the existence of additional identical elements in the process, method, article, or device that includes the element.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A vehicle collision detection method, comprising the following steps:
S100: acquiring a collection of obstacle information within a preset range of a current vehicle, and dividing the collection of obstacle information into a first obstacle map and a second obstacle map based on a preset obstacle height;
S200: modeling the current vehicle based on the first obstacle map and the second obstacle map, and fusing vehicle models with the corresponding obstacle maps to obtain a first collision detection model and a second collision detection model, respectively; and
S300: obtaining a distance relationship between a preset position of the current vehicle and obstacles corresponding to the collection of obstacle information through the first collision detection model and/or the second collision detection model, and determining whether the current vehicle is in collision based on the distance relationship.

2. The vehicle collision detection method according to claim 1, wherein the dividing the collection of obstacle information into a first obstacle map and a second obstacle map based on a preset obstacle height in step S100 comprises:
calibrating maximum lengths of front wheels and rear wheels of the current vehicle, respectively, and setting the preset obstacle height according to calibration results; and
determining whether heights of the obstacles corresponding to the collection of obstacle information are greater than the preset obstacle height, if yes, classifying the obstacles into the first obstacle map, otherwise classifying the obstacles into the second obstacle map.

3. The vehicle collision detection method according to claim 2, wherein step S200 comprises:
modeling the current vehicle to obtain a first vehicle model comprising a front overhang and a rear overhang of the vehicle, and a second vehicle model with the front overhang and the rear overhang of the vehicle removed; and
fusing the first vehicle model and the second vehicle model with the first obstacle map and the second obstacle map, respectively, to obtain the first collision detection model and the second collision detection model.

4. The vehicle collision detection method according to claim 3, wherein before performing step S300, the method comprises:
building a first rectangular coordinate system with a geometric center of the current vehicle as a first origin, a width direction of the current as an x-axis, and a length direction of the vehicle as a y-axis.

5. The vehicle collision detection method according to claim 4, wherein before performing step S300, the method further comprises:
building a second rectangular coordinate system with a midpoint of a rear axle of the current vehicle as a second origin, the width direction of the vehicle as an X-axis, and the length direction of the vehicle as a Y-axis.

6. The vehicle collision detection method according to claim 5, wherein step S300 comprises:
S301: acquiring, in the first collision detection model, initial obstacle coordinates of the obstacles under the first rectangular coordinate system;
S302: calculating a distance between each obstacle and the first origin based on the initial obstacle coordinates and coordinates of the first origin,
if the distance between at least one of the obstacles and the first origin is smaller than a first preset distance, performing step S303, otherwise performing step S305;
S303: acquiring transformed obstacle coordinates of obstacles in a first preset circular region under the second rectangular coordinate system, and proceeding to step S304;
S304: calculating a distance between each obstacle in the first preset circular region and the second origin based on the transformed obstacle coordinates and coordinates of the second origin,
if the distance between at least one of the obstacles in the first preset circular region and the second origin is smaller than a second preset distance, determining that the current vehicle is in collision, otherwise performing step S305; and
S305: determining that the current vehicle has no risk of collision, wherein
the first preset circle region takes the first origin as a center of the circle and the first preset distance as a radius.

7. The vehicle collision detection method according to claim 5, wherein step S300 comprises:
S311: acquiring, in the second collision detection model, initial obstacle coordinates of the obstacles under the first rectangular coordinate system;
S312: calculating a distance between each obstacle and the first origin based on the initial obstacle coordinates and coordinates of the first origin,
if the distance between at least one of the obstacles and the first origin is smaller than a third preset distance, performing step S313, otherwise performing step S315;
S313: acquiring transformed obstacle coordinates of obstacles in a second preset circular region under the second rectangular coordinate system, and proceeding to step S314;
S314: calculating a distance between each obstacle in the second preset circular region and the second origin based on the transformed obstacle coordinates and coordinates of the second origin,
if the distance between at least one of the obstacles in the second preset circular region and the second origin is smaller than a second preset distance, determining that the current vehicle is in collision, otherwise performing step S315; and
S315: determining that the current vehicle has no risk of collision, wherein
the second preset circle region takes the first origin as a center of the circle and the third preset distance as a radius.

8. The vehicle collision detection method according to claim 6, wherein step S303 or step S313 specifically comprises:
acquiring a vehicle heading angle, corresponding initial obstacle coordinates of the obstacles in the first preset circular region or the second preset circular region under the first rectangular coordinate system, and coordinates of the midpoint of the rear axle of the vehicle under the first rectangular coordinate system;
calculating a first included angle based on the initial obstacle coordinates and the coordinates of the midpoint of the rear axle of the vehicle, and calculating a distance between each obstacle and the midpoint of the rear axle of the vehicle, wherein the first included angle is an included angle between a connecting line of each obstacle and the midpoint of the rear axle of the vehicle and a perpendicular line segment from the obstacle to the X-axis of the second rectangular coordinate system;
calculating a second included angle based on the first included angle and the vehicle heading angle; and
calculating the transformed obstacle coordinates of each obstacle based on the distance between the obstacle and the midpoint of the rear axle of the vehicle and the second included angle.

9. The vehicle collision detection method according to claim 8, wherein when it is determined that the current vehicle is in collision, step S304 or S314 further comprises: issuing a collision warning message.

10. A vehicle collision detection system, comprising:
a first acquisition module configured to acquire a collection of obstacle information within a preset range of a current vehicle;
a dividing module configured to divide the collection of obstacle information into a first obstacle map and a second obstacle map based on a preset obstacle height;
a second acquisition module configured to model the current vehicle configured based on the first obstacle map and the second obstacle map, and fuse vehicle models with the corresponding obstacle maps to obtain a first collision detection model and a second collision detection model, respectively; and
a determining module configured to obtain a distance relationship between a preset position of the current vehicle and obstacles corresponding to the collection of obstacle information through the first collision detection model and/or the second collision detection model, and determine whether the current vehicle is in collision based on the distance relationship.

11. The system according to claim 10, further comprising:
a building module configured to build a first rectangular coordinate system and a second rectangular coordinate system, wherein the first rectangular coordinate system takes a geometric center of the current vehicle as a first origin, a width direction of the current as an x-axis, and a length direction of the vehicle as a y-axis; and the second rectangular coordinate system takes a midpoint of a rear axle of the current vehicle as a second origin, the width direction of the vehicle as an X-axis, and the length direction of the vehicle as a Y-axis; and
a warning module configured to issue a collision warning message when it is determined that the current vehicle is in collision.

12. The system according to claim 11, wherein the dividing module comprises:
a calibration unit configured to calibrate maximum lengths of front wheels and rear wheels of the current vehicle;
a setting unit configured to set the preset obstacle height according to calibration results of the calibration unit; and
a dividing unit configured to determine whether heights of the obstacles corresponding to the collection of obstacle information are greater than the preset obstacle height;
if yes, classify the obstacles into the first obstacle map; otherwise, classify the obstacles into the second obstacle map.

13. The system according to claim 12, wherein the second acquisition module comprises:
a modeling unit configured to obtain a first vehicle model and a second vehicle model; and
a fusion unit configured to fuse the first vehicle model and the second vehicle model with the first obstacle map and the second obstacle map, respectively, to obtain the first collision detection model and the second collision detection model.

14. The system according to claim 13, wherein the determining module comprises:
an acquisition unit configured to acquire, in the first collision detection model or the second collision detection model, initial obstacle coordinates of the obstacles under the first rectangular coordinate system;
a first calculation unit configured to calculate a distance between each obstacle and the first origin based on the initial obstacle coordinates and coordinates of the first origin to obtain transformed obstacle coordinates of obstacles in a second preset circular region under the second rectangular coordinate system when the distance is smaller than a first preset distance or a third preset distance; and
a second calculation unit configured to calculate a distance between each obstacle in the second preset circular region to the second origin based on the transformed obstacle coordinates and coordinates of the second origin, so as to determine that the current vehicle is in collision when the distance is smaller than a second preset distance.

15. A vehicle, wherein the vehicle is configured with a vehicle collision detection system, and the system detects whether a current vehicle is in collision using the vehicle collision detection method according to claim 1.
